(19) United States
(12) Patent Application Publication
(10) Pub. No.: US 2026/0219955 A1
(43) Pub. Date: Jul. 30, 2026

(54) MODEL RUNTIME ORCHESTRATION USING NETWORK NODE LOCALIZATION CONTEXT

(71) Applicant: DELL PRODUCTS L.P., Round Rock, TX (US)

(72) Inventors: Spencer Bull, Conroe, TX (US); Tyler Cox, Austin, TX (US); Jacob Mink, Cedar Park, TX (US)

(21) Appl. No.: 19/037,036

(22) Filed: Jan. 24, 2025

(51) Int. Cl. G06F 9/50; G06F 11/34

(52) U.S. Cl. CPC G06F 9/5055; G06F 11/3428

(57) ABSTRACT

An information handling system receives a request for an artificial intelligence interaction and determines requirements of an artificial intelligence model associated with the request for the artificial intelligence interaction. The information handling system also evaluates a capability of the information handling system based on processing units of the information handling system and discovers artificial intelligence-capable information handling systems in a local network and a private extended network. In addition, the information handling system generates a list of the discovered artificial intelligence-capable information handling systems in the local network and the private extended network. The list of the discovered artificial intelligence-capable information handling systems includes the information handling system. Further, the information handling system selects a primary information handling system for execution of the request from the list of the discovered artificial intelligence-capable information handling systems.

### FIELD OF THE DISCLOSURE

The present disclosure generally relates to information handling systems, and more particularly relates to model runtime orchestration using network node localization context.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system may receive a request for an artificial intelligence interaction and determine requirements of an artificial intelligence model associated with the request for the artificial intelligence interaction. The information handling system also may evaluate a capability of the information handling system based on processing units of the information handling system and discover artificial intelligence-capable information handling systems in a local network and a private extended network. In addition, the information handling system may generate a list of the discovered artificial intelligence-capable information handling systems in the local network and the private extended network. The list of the discovered artificial intelligence-capable information handling systems includes the information handling system. Further, the information handling system may select a primary information handling system for execution of the request from the list of the discovered artificial intelligence-capable information handling systems.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an environment configured for model runtime orchestration using network node localization context, according to an embodiment of the present disclosure;

FIG. 2 is a block diagram an information handling system configured for model runtime orchestration using network node localization context, according to an embodiment of the present disclosure;

FIGS. 3 and 4 are flowcharts of a method for model runtime orchestration using network node localization, according to an embodiment of the present disclosure; and

FIG. 5 is a block diagram of an information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

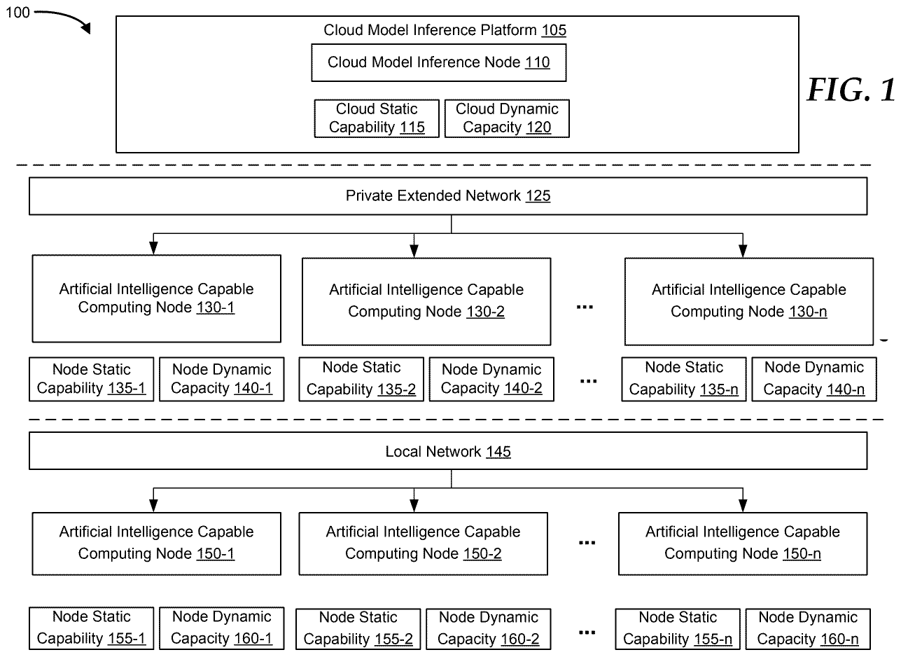

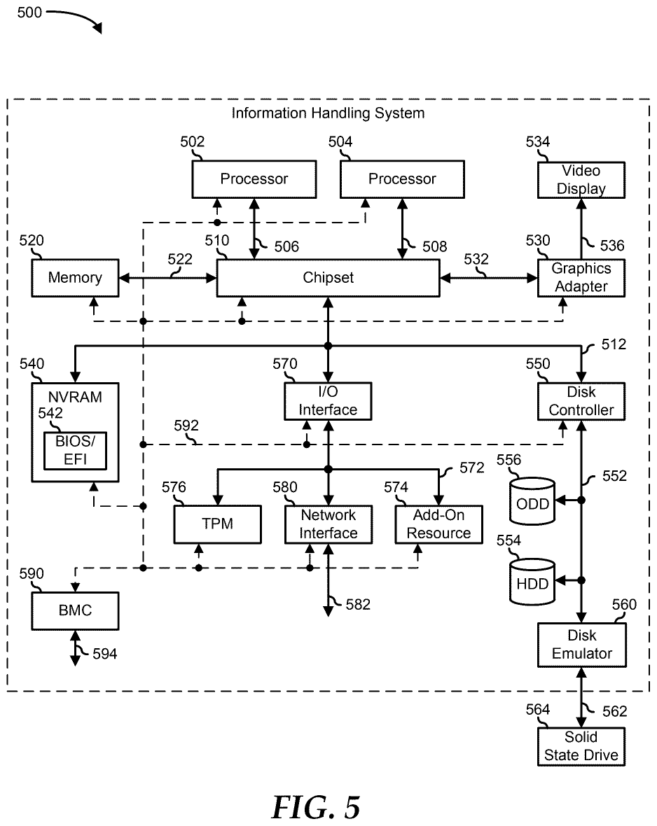

FIG. 1 illustrates a portion of an environment 100 configured for model runtime orchestration using network node localization context, according to an embodiment of the present disclosure. Environment 100 includes a cloud model inference platform 105, a private extended network 125, and a local network 145. Cloud model inference platform 105 may be implemented in a public network, such as the Internet. Each one of cloud model inference platform 105, private extended network 125, and local network 145 includes an information handling system, which is similar to information handling system 500 of FIG. 5. The computing nodes within a network may be communicatively coupled to other computing nodes within the network. However, connections between the computing nodes may be omitted for descriptive clarity.

The information handling systems, also referred to as computing nodes, may be a personal computer, a desktop computer system, a laptop computer system, a server computer system, a mobile device, a tablet computing device, a personal digital assistant, a consumer electronic device, an electronic music player, an electronic camera, an electronic video player, a wireless access point, a network storage device, or any other suitable computing device. The information handling system may also be a portable information handling system that may include a laptop, a notebook, a smartphone, a tablet, or a personal digital assistant, among others.

Cloud model inference platform 105 includes a cloud model inference node 110 with a cloud static capability and a cloud dynamic capacity 120. Cloud model inference platform 105 may be any suitable infrastructure where model inference may be performed to generate prediction responses. In one embodiment, the model inference may be performed at one or more cloud model inference nodes, such as cloud model inference node 110. Cloud model inference node 110 may be associated with a cloud static capability 115 and a cloud dynamic capacity 120.

Cloud static capability 115 may refer to the current processing capability of cloud model inference node 110. For example, cloud static capability 115 may be based on what type of processing unit(s) that cloud model inference node 110 currently has and associated performance metric. The processing units may include central processing units (CPUs), graphics processing units (GPUs), system-on-chips (SOCs), or neural processing units (NPUs). Cloud static capability 115 may also indicate whether the GPUs or NPUs of cloud model inference node 110 are integrated or discrete. One performance metric that can be used may be operations per second of each processing unit. For example, NPUs are typically designed to handle artificial intelligence (AI) models with large data input, including images and video.

Cloud dynamic capacity 120 may indicate the ability of the processing units of cloud model inference node to perform model inference at a particular time period. Cloud dynamic capacity 120 may be determined based on various factors, such as current utilization state, power state, currently downloaded hot AI models versus cold AI models, etc. For example, if there is an AI model currently loaded in memory, then cloud dynamic capacity 120 of cloud model inference node 110 may be lower than when there is no AI model in memory.

Private extended network 125 may be any suitable network of information handling systems that may be linked to information handling systems at local network 145, such as when an employee uses a virtual private network (VPN) to access a corporate network. As such, the accessible information handling systems in the corporate network can be designated as part of the private extended network.

Private extended network 125 includes AI-capable computing nodes 130-1 through 130-n. Each one of AI-capable computing nodes 130-1 through 130-n includes a node static capability and a node dynamic capacity. For example, AI-capable computing node 130-1 includes a node static capability 135-1 and a node dynamic capacity 140-1. AI-capable computing node 130-2 includes a node static capability 135-2 and node dynamic capacity 140-2. Determining node static capability of each computing node in private extended network 125 may be similar to determining cloud static capability 115 of cloud model inference node 110. In addition, determining the node dynamic capacity of each computing node in private extended network 125 may be similar to determining cloud dynamic capacity 120 of cloud model inference node 110.

Local network 145 may be any suitable network, such as a Bluetooth® Low Energy (LE) wireless network, a Bluetooth® wireless network, or a near-field communication (NFC) network, which connects information handling systems within a location like a home or office. Local network 145 includes AI-capable computing nodes 150-1 through 150-n. Similar to above, each one of AI-capable computing nodes 150-1 through 150-n includes a node static capability and a node dynamic capacity. For example, AI-capable computing node 150-1 includes a node static capability 155-1 and a node dynamic capacity 160-1. AI-capable computing node 150-2 includes a node static capability 155-2 and node dynamic capacity 160-2. Determining node static capability of each computing node in local network 145 may be similar to determining cloud static capability 115 of cloud model inference node 110. In addition, determining the node dynamic capacity of each computing node in local network 145 may be similar to determining cloud dynamic capacity 120 of cloud model inference node 110.

The exponential growth of AI models and user demand for real-time AI interactions introduces challenges in determining where to execute AI workloads efficiently. Current solutions generally lack a dynamic, context-aware orchestration system to localize and optimize model inference across a heterogeneous network of compute nodes that include a local computing device, a near-field communication network, a private network, and a public cloud. The issue lies in balancing various factors, such as device capabilities, power states, and user policies with dynamic compute availability and experience requirements for optimal AI performance across the AI-capable computing nodes available to the user and device. To address this issue and other concerns, the present disclosure provides a system and method for model runtime orchestration using network node localization context. For example, when a user requests an AI interaction, such as to execute a large language model (LLM), a model runtime orchestration system may dynamically identify where to execute a workload associated with the request, such as locally on the user's device, nearby capable devices, or remote computing nodes, while considering performance, latency, power constraints, and security policies of each of the computing nodes or devices.

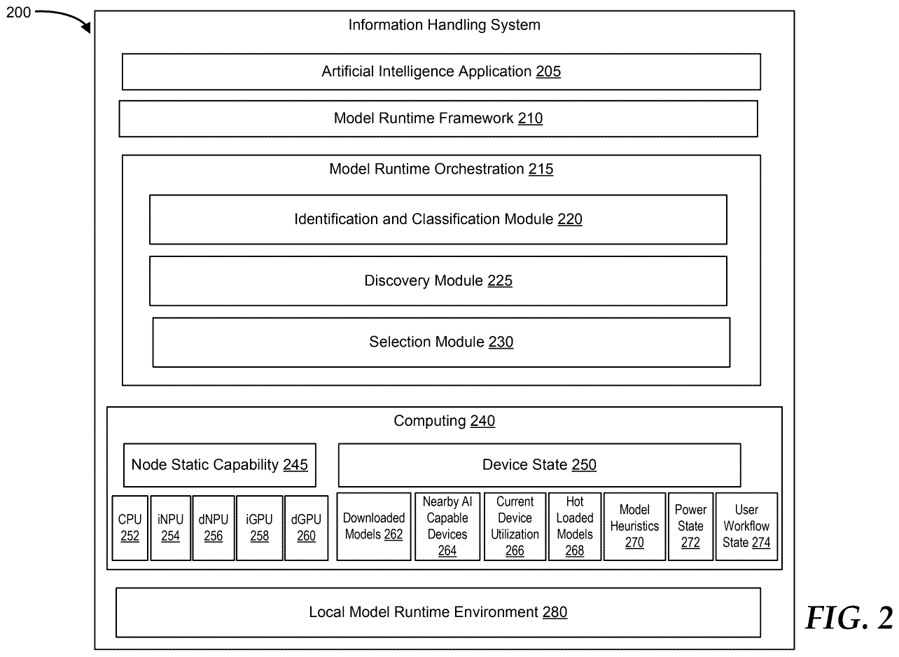

FIG. 2 illustrates a portion of an information handling system 200 that is configured for model runtime orchestration using network node localization context, according to an embodiment of the present disclosure. Information handling system 200 may be an AI-capable computing node similar to one or more computing nodes in FIG. 1. Information handling system 200 includes an AI application 205, a model runtime framework 210, a model runtime orchestration 215, a computing 240, and a local model runtime environment 280. Computing 240 includes a node static capability 245 and a device state 250. Node static capability245 can be based on the properties of one or more processing units of information handling system 200, such as a CPU 252, an integrated NPU (iNPU) 254, a discrete NPU (dNPU) 256, integrated GPU (iGPU) 258, a discrete GPU (dGPU) 260. Device state 250 can be associated with downloaded models 262, nearby AI-capable devices 264, a current device utilization 266, hot-loaded models 268, model heuristics 270, a power state 272, and a user workflow state 274.

AI application 205, model runtime framework 210, model runtime orchestration 215, computing 240, and local model runtime environment 280 may be communicatively coupled. However, any variety of connections between the aforementioned components of information handling system 200 are envisioned as falling within the scope of the present disclosure. In addition, connections between components may be omitted for descriptive clarity.

AI application 205 may be an AI-powered software, such as a conversational AI application, also referred to as chatbots or virtual assistants. Model runtime framework 210 may be configured to provide a platform for the execution of AI applications, such as AI application 205. In one embodiment, model runtime framework 210 may include one or more software components that service the application, such as by assigning the application to a runtime environment. For example, model runtime framework 210 may assign AI application 205 to local model runtime environment 280.

Model runtime orchestration 215 may include any system, device, or apparatus configured to identify, evaluate, and orchestrate AI inference across localized and distributed compute contexts. Model runtime orchestration 215 is designed to integrate with evolving AI compute infrastructures, including federated learning and distributed inference frameworks for AI workloads on more capable devices in the future. Model runtime orchestration 215 includes a model requirements identification and classification module 220, a discovery module 225, and a selection module 230.

Identification and classification module 220 may comprise any system, device, or apparatus configured to determine the requirements of the AI model associated with the request for AI inference, such as load time and inference time, based on benchmarking model performance and project utilization. In addition, identification, and classification module 220 may determine a projected performance based on device-specific capabilities and dynamic capacity calculated from collected and/or received telemetry data. Discovery module 225 may comprise any system, device, or apparatus configured for real-time discovery of AI-capable computing nodes across local and extended networks, leveraging near-field communication, private network nodes, and cloud resources. For example, discovery module 225 may discover the computing nodes associated with cloud model inference platform 105, private extended network 125, and local network 145.

Selection module 230 may comprise any system, device, or apparatus configured to perform model inference orchestration by selecting a compute node for execution of the request. In particular, selection module 230 may determine a computing score for each discovered computing node, wherein the computing score may be based on various parameters associated with the request, such as token count, model size, latency sensitivity, and power states. Selection module 2350 may then rank the computing nodes based on their computing scores, resulting in a ranked list of computing nodes. Based on the ranked list, selection module 230 may select an optimal computing node for the model inference based on the AI request parameters and fallback strategies. Examples of AI request parameters include token count, model size, latency sensitivity, and power state, among others. General request parameters include model type, model size, task type, token count, latency sensitivity, throughput requirements, inference precision, mode of execution, and privacy. The model type parameter may refer to a specific model request, such as whether the request for user interaction specified a large language model, a small language model, a vision model, etc. The model size parameter may refer to a computational intensity, such as a number of parameters and file size.

The task type parameter may refer to batch inference versus streaming inference. The token count parameter, which is a parameter specific to language models, may refer to the number of tokens or input data length. The latency sensitivity parameter may refer to how time critical is the response. The throughput requirements parameter may refer to the volume of requests that need to be handled concurrently. The inference precision parameter may refer to required model accuracy, such as FP32, INT8, etc. The mode of execution parameter may refer to whether the interaction is in the foreground or background. The privacy parameter may refer to data requirements or flags around the privacy of the location or computing node where the request is allowed to run.

Device-specific parameters include local resource utilization, power state, network connectivity, pre-loaded models, user workflow state, and device heuristics. The local resource utilization parameter may refer to the current CPU, GPU, NPU, and memory usage of a computing node. The power state parameter may refer to the current battery level, such as whether the computing node is in a power-saving mode or not, or whether it is plugged in or not, among others. The network connectivity parameter may refer to the current bandwidth, latency, and reliability of the connection of the computing node. The pre-loaded model parameters may refer to whether models are already available locally on the information handling system, which minimizes setup time. The user workflow state parameter may refer to the context of the user's activity, such as whether the user is actively gaming, working, or idle. The device heuristics parameter may refer to computing scores based on benchmark emulation results.

Context and localization parameters include localization context, geographical region, and available nodes. The localization context parameter may refer to determining a current location of the computing node, such as whether the computing node is part of a local network, a private extended network, or the cloud. For example, computing nodes may be located in a near-field network, such as phones, laptops, webcams, mouse, keyboards, etc. In another example, the computing node may be located in a local network, such as a server or a router in a home or office network. The computing node may also be located in a private extended network or the cloud. The geographical region parameter may refer to regulatory or performance constraints based on the geographical location of the computing node, such as whether the computing node is located locally or remotely. The available nodes parameter may refer to discovered computing nodes with AI capabilities in the current context.

Experience flags parameters include real-time versus deferred execution, cost sensitivity, security level, and energy efficiency preference. The real-time versus deferred execution parameter may refer to whether the request can tolerate delays. The cost sensitivity parameter may refer to budget considerations for using cloud or private network computing nodes. The security level parameter may refer to the sensitivity of the data and preferred computing nodes for execution, such as locally for privacy. The energy efficiency preference parameter may refer to a trade-off between performance and power consumption.

Policy and user preferences parameters may include user policies, enterprise policies, and fallback options. The user policies parameter may refer to constraints set by the user, such as not using the cloud for AI tasks. The enterprise policies parameter may refer to information technology administrator constraints, such as which specific computing nodes or networks are allowed to run the user request. The fallback options parameter may refer to whether fallback computing nodes should be considered for the execution of the user request and in what order.

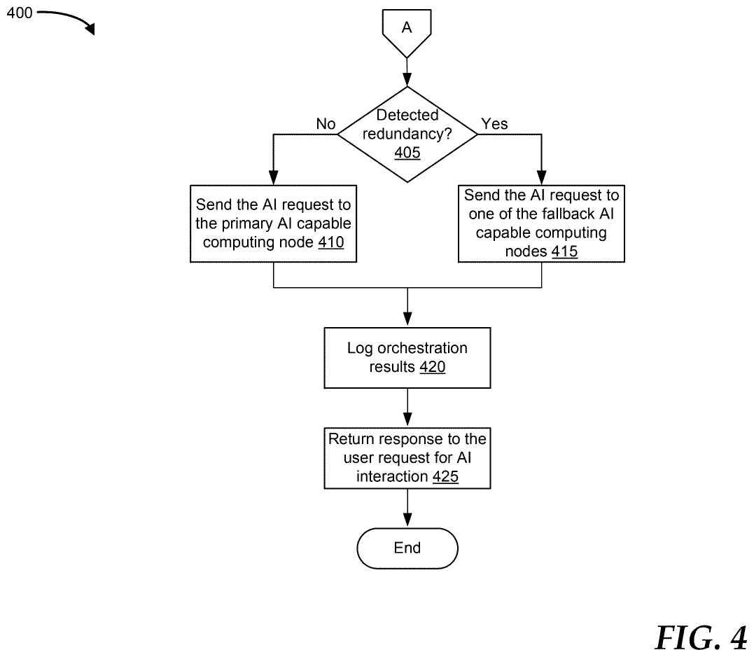

CPU 252, which is similar to processors 502 and 504 of FIG. 4, may be configured to execute instructions of an AI application, such as AI application 205. GPUs may comprise any system, device, or apparatus configured to process graphical or visual content and to communicate that content to a monitor or display where the content may be rendered, similar to a graphics adapter 530 of FIG. 5. GPUs typically include more specialized cores than CPUs, which results in the ability to compute results of intensive AI workloads. GPUs may be discrete from or integrated with an information handling system, such as integrated GPU (iGPU) 258 and discrete GPU (dGPU) 260.

NPUs may comprise any system, device, or apparatus, such as a hardware accelerator that is designed for AI and machine learning tasks. NPUs are typically optimized to handle the complex computations required by deep learning algorithms. This optimization makes NPUs efficient at processing AI tasks, such as natural language processing, image analysis, and more. NPUs may be discrete from or integrated with an information handling system, such as integrated NPU (iNPU) 254 and discrete NPU (dNPU) 256. In one embodiment, an information handling system with a GPU and/or an NPU may have a higher capability to execute an AI application than an information handling system with only a CPU. Accordingly, the capability of the information handling system may be based on the speed, such as operations per second, of each processing unit or a combination thereof.

Downloaded models 262 may refer to whether information handling system 200 already has downloaded AI models, as this may require less setup. Nearby AI capable devices 264 may refer to devices that may have a wired connection to information handling system 200 and/or communicatively coupled to information handling system 200 via a short-range wireless connection, such as Bluetooth®, Wi-Fi®, NearLink®, NFC, low-power wide-area network, ultra-wideband, Institutes of Electrical and Electronics Engineers (IEEE) 802.15, or similar.

In addition, physical devices or peripherals that are plugged in or associated with device 150 or other information handling systems that are physically connected to information handling system 135 or via a short-range wireless connection may also be classified as “near the box” devices or information handling systems. This includes a webcam, keyboard, monitor, or other devices that are connected to information handling system 135 and/or device 150.

Current device utilization 266 may refer to the current percentage of usage of processing units and/or memory of the information handling system among other components. Hot-loaded models 268 may refer to the number of AI models currently loaded in the memory of information handling system 200. Model heuristics 270 may refer to a compute footprint of the AI model, which may be used to estimate the impact of the AI model on power state 272 and user workflow state 274 of information handling system 200. Power states 272 may refer to the current power state of information handling system 200 which may correspond to the power states defined in the Advanced Configuration and Power Interface (ACPI) specification. User workflow state 274 may refer to the current status of the AI model workflow, such as whether the workflow is in a running state, a finished state, etc. Local model runtime environment 280 may be configured to provide an infrastructure that allows AI applications to run locally. The operations described herein as being performed by one or more components of AI application 205, model runtime framework 210, model runtime orchestration 215, and local model runtime environment 280 may be performed or executed by one or more processing units of information handling system 200.

Those of ordinary skill in the art will appreciate that the configuration, hardware, and/or software components of information handling system 200 depicted in FIG. 2 may vary. For example, the illustrative components within Information handling system 200 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

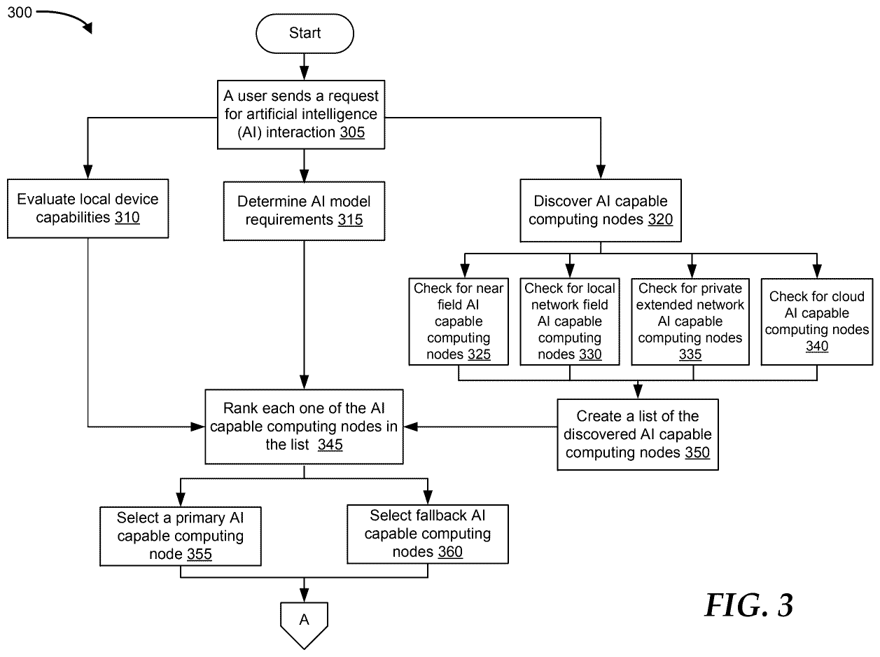

FIG. 3 illustrates a portion of a flowchart of a method 300 for model runtime orchestration using network node localization, according to an embodiment of the present disclosure. Method 300 may be performed by any suitable component of environment 100 of FIG. 1 and Information handling system 200 of FIG. 2 including but not limited to model runtime orchestration 215 of FIG. 2. While embodiments of the present disclosure are described in terms of the components of environment 100 of FIG. 1 and information handling system 200 of FIG. 2, it should be recognized that other components may be utilized to perform the described method. One of skill in the art will appreciate that this flow chart explains a typical example, which can be extended to applications or services in practice. It will be readily appreciated that not every operation set forth in this flow chart is always necessary and that certain operations may be combined, performed simultaneously, in a different order, or perhaps omitted, without varying from the scope of the disclosure. One of skill in the art will appreciate that this flow chart explains a typical example, which can be extended to applications or services in practice.

In one embodiment, method 300 may perform dynamic context-aware model inference by integrating real-time device telemetry and localization context of computing nodes relative to its network. This is done to orchestrate AI workloads dynamically across multiple compute nodes starting from the user's local computing device. In addition, method 300 may perform scalable multi-tier orchestration by enabling a seamless interplay between device-local, edge, and cloud computing nodes optimizing for performance, cost, and user policies. This may result in enhanced user experience, which may be due to prioritizing AI workload execution to match user-defined or system-optimized parameters, such as power efficiency, latency, model fidelity, or accuracy.

Method 300 typically starts at block 305 where a user requests an AI interaction which may include an AI application utilizing one or more AI models. The user request may be received by an information handling system via a user communication interface and provided to the model runtime framework. For example, the user request may be transmitted via an application programming interface (API), such as representational state transfer (REST), remote procedure call (RPC), etc. The model runtime framework may then determine one or more properties associated with the AI model(s), such as the type and size of the AI model that the application is going to use. Other properties may include latency, token count if the AI model is a language model, mode of execution, security and cost, power efficiency, etc. These properties may be based on preferences associated with the AI application. Subsequent to receiving the request, the model runtime framework may notify a model runtime orchestration module of the received request. The model runtime orchestration module may then perform blocks 310, 315, and 320. In one embodiment, blocks 310, 315, and 320 may be performed in parallel.

At block 310, the model runtime orchestration module may evaluate local device capabilities and/or capacity. In one embodiment, the model runtime orchestration module may determine the static capability of the information handling system. For example, the model runtime orchestration module may discover processing capabilities of the information handling system, such as architecture, operating system, system manufacturer, model, software dependencies, silicon properties, capabilities of AI processing chip(s), etc. For example, the model runtime orchestration module may determine whether the information handling system includes one or a combination of processing units, such as a CPU, GPU, NPU, or similar.

In addition, the model runtime orchestration module may discover properties associated with each processing unit. For example, the model runtime orchestration module may determine whether the CPU of the information handling system is an Apple M1®/M2®, Intel i5®/i7®, Qualcomm Snapdragon®, etc. In addition, the model runtime orchestration module may determine a manufacturer of a CPU or GPU of the client device. For example, the model runtime orchestration module may determine whether the processing unit of the client device is manufactured by Intel®, AMD®, or Nvidia®. In another example, the model runtime orchestration module may determine whether the operating system is an Apple iOS®, Microsoft Windows®, Linux® OS, etc.

The model runtime orchestration module may also determine the current state or capacity of the information handling system. For example, the model runtime orchestration module may determine whether the information handling system may determine properties of downloaded AI models if any, properties of nearby AI capable devices, current utilization rate, properties of hot loaded AI models, information associated with model heuristics, current power state, current user workflow or workload state, among others.

At block 315, the model runtime orchestration module may determine various requirements of the AI model associated with the user request based on the performance results of a benchmarking process of the AI model and project utilization. For example, the model runtime orchestration module may determine the amount of processing power and memory requirement of the AI model based on various emulated scenarios. The performance results may provide expectations of the behavior of the AI models which can be used whether a computing node can support the execution of the AI based on its capabilities and the current capacity of the information handling system.

In one embodiment, the benchmarking process may have been performed prior to the receipt of the request, such as during the development of the application. Accordingly, the performance results may have been available for download by the model runtime orchestration module. Otherwise, the model runtime orchestration module may perform tests designed to assess the performance of the AI model across various tasks, capabilities, and capacities of the AI-capable computing node. For example, the performance results may provide data for the execution of the AI model when an AI-capable computing node with similar capability to the information handling system has limited device capacity or at a capacity that is similar to the current capacity of the information handling system.

At block 320, the model runtime orchestration module may discover AI-capable computing nodes based on the performance of blocks 325, 330, 335, and 340. The discovery may be performed via a mesh or discovery service. The model runtime orchestration module may also evaluate the capability and current capacity of each AI-capable computing node during discovery. At block 325, the model runtime orchestration module may check for near-field AI-capable computing nodes. At block 330, the model runtime orchestration module may check for local network field AI-capable computing nodes. At block 335, the model runtime orchestration module may check for private extended network AI-capable computing nodes. At block 340, the model runtime orchestration module may check for AI-capable computing nodes in the loud. At block 350, the model runtime orchestration module may compile the discovered AI-capable computing nodes into a list. The list may also include descriptions of the static capabilities of the AI-capable computing nodes and their current capacity.

At block 345, the model runtime orchestration module may determine and associate a computing score with each AI-capable computing node in the list and the local information handling system that received the request. The computing score may be based on the performance expectations of the AI model according to the benchmarking results. For example, a high computing score may reflect an expectation that the computing node can meet the requirements of the AI model based on the capability and current capacity of the computing node. The higher the expectation that the requirements can be met, the higher the computing score that is assigned to the computing node. For example, on a computing score range of zero to ten, with ten being the highest score, the computing device that is expected to meet all the requirements of the AI model may be given a score of 10. Conversely, if the computing node is not expected to meet the requirements of the AI model, then the computing node may be assigned a lower score. In addition, the computing node may be given a computing score of zero when the execution of the AI model is restricted to a particular computing node.

The model runtime orchestration module may then rank each of the AI-capable computing nodes along with the local information handling system based on the computing score. For example, the ranking may be ordered according to the computing scores of the AI-capable computing nodes, wherein the AI-capable computing node with the highest score may be ranked first and the AI-capable computing node with the lowest score may be ranked last. In addition to the computing score, the ranking may also reflect policy considerations, such as based on geographical considerations. For example, assuming that two computing nodes have the same computing score, a computing node in the local network may be ranked higher than the computing node in the cloud while the information handling system that receives the request may be ranked higher than a computing node in the local network. The method may proceed to blocks 355 and 360.

At block 355, the model runtime orchestration module may select a primary AI-capable computing node based on the ranking. In one embodiment, the AI-capable computing device with the highest ranking may be selected as the primary computing node. At block 360, the model runtime orchestration module may select at least one AI-capable computing node as a fallback computing node. In one embodiment, the fallback computing nodes may be an AI-capable computing node that is ranked with the second highest score. The number of fallback computing nodes may be indicated by the model runtime orchestration module or an administrator. The fallback computing nodes may be utilized when there is an issue with the primary computing node, such as when a connection to the primary computing node fails.

FIG. 4 illustrates a portion of a flowchart of a method 400 which is a continuation of method 300 of FIG. 3. Method 400 typically starts at decision block 405, where the model runtime orchestration module may determine if there are redundant AI capable computing nodes among the primary computing node and the fallback computing nodes. For example, redundancy is detected if the primary computing node is also listed as a fallback computing node. Redundancy is also detected if an AI-capable computing node appears at least twice in the list of fallback computing nodes. If there is no detected redundancy, then the “NO” branch is taken, and the method proceeds to block 410. If redundancy is detected, then the “YES” branch is taken, and the method proceeds to block 415.

At block 410, the model runtime orchestration module may send the AI request to the primary AI-capable computing node for execution. At block 415, the model runtime orchestration module may send the AI request to one of the fallback AI-capable computing nodes for execution, such as to the highest-ranking fallback AI-capable computing node. The method may proceed to block 420, where the model runtime orchestration module may log orchestration results. For example, the model runtime orchestration module may log information associated with the selection of the primary AI-capable computing node and the fallback AI-capable nodes. The information may include the computing scores and ranking of the AI-capable computing nodes. The method may proceed to block 425 where the model runtime framework may return the results of the user request for AI interaction.

FIG. 5 illustrates an embodiment of an information handling system 500 including processors 502 and 504, a chipset 510, a memory 520, a graphics adapter 530 connected to a video display 534, a non-volatile RAM (NVRAM) 540 that includes a basic input and output system/extensible firmware interface (BIOS/EFI) module 542, a disk controller 550, a hard disk drive (HDD) 554, an optical disk drive 556, a disk emulator 560 connected to an SSD 564, an I/O interface 570 connected to an add-on resource 574 and a trusted platform module (TPM) 576, a network interface 580, and a baseboard management controller (BMC) 590. Processor 502 is connected to chipset 510 via processor interface 506, and processor 504 is connected to the chipset via processor interface 508. In a particular embodiment, processors 502 and 504 are connected together via a high-capacity coherent fabric, such as a HyperTransport link, a QuickPath Interconnect, or the like. Chipset 510 represents an integrated circuit or group of integrated circuits that manage the data flow between processors 502 and 504 and the other elements of information handling system 500. In a particular embodiment, chipset 510 represents a pair of integrated circuits, such as a northbridge component and a southbridge component. In another embodiment, some or all of the functions and features of chipset 510 are integrated with one or more of processors 502 and 504.

Memory 520 is connected to chipset 510 via a memory interface 522. An example of memory interface 522 includes a Double Data Rate (DDR) memory channel and memory 520 represents one or more DDR Dual In-Line Memory Modules (DIMMs). In a particular embodiment, memory interface 522 represents two or more DDR channels. In another embodiment, one or more of processors 502 and 504 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 520 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 530 is connected to chipset 510 via a graphics interface 532 and provides a video display output 536 to a video display 534. An example of a graphics interface 532 includes a Peripheral Component Interconnect-Express (PCIe) interface and graphics adapter 530 can include a four-lane (x4) PCIe adapter, an eight-lane (x8) PCIe adapter, a 16-lane (x16) PCIe adapter, or another configuration, as needed or desired. In a particular embodiment, graphics adapter 530 is provided down on a system printed circuit board (PCB). Video display output 536 can include a Digital Video Interface (DVI), a High-Definition Multimedia Interface (HDMI), a DisplayPort interface, or the like, and video display 534 can include a monitor, a smart television, an embedded display such as a laptop computer display, or the like.

NVRAM 540, disk controller 550, and I/O interface 570 are connected to chipset 510 via an I/O channel 512. An example of I/O channel 512 includes one or more point-to-point PCIe links between chipset 510 and each of NVRAM 540, disk controller 550, and I/O interface 570. Chipset 510 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface, a Universal Serial Bus (USB), another interface, or a combination thereof. NVRAM 540 includes BIOS/EFI module 542 that stores machine-executable code (BIOS/EFI code) that operates to detect the resources of information handling system 500, to provide drivers for the resources, to initialize the resources, and to provide common access mechanisms for the resources. The functions and features of BIOS/EFI module 542 will be further described below.

Disk controller 550 includes a disk interface 552 that connects the disc controller to an HDD 554, to an optical disk drive (ODD) 556, and to disk emulator 560. An example of disk interface 552 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 560 permits SSD 564 to be connected to information handling system 500 via an external interface 562. An example of external interface 562 includes a USB interface, an institute of electrical and electronics engineers (IEEE) 1394 (Firewire) interface, a proprietary interface, or a combination thereof. Alternatively, SSD 564 can be disposed within information handling system 500.

I/O interface 570 includes a peripheral interface 572 that connects the I/O interface to add-on resource 574, to TPM 576, and to network interface 580. Peripheral interface 572 can be the same type of interface as I/O channel 512 or can be a different type of interface. As such, I/O interface 570 extends the capacity of I/O channel 512 when peripheral interface 572 and the I/O channel are of the same type, and the I/O interface translates information from a format suitable to the I/O channel to a format suitable to the peripheral interface 572 when they are of a different type. Add-on resource 574 can include a data storage system, an additional graphics interface, a network interface card (NIC), a sound/video processing card, another add-on resource, or a combination thereof. Add-on resource 574 can be on a main circuit board, on a separate circuit board, or add-in card disposed within information handling system 500, a device that is external to the information handling system, or a combination thereof.

Network interface 580 represents a network communication device disposed within information handling system 500, on a main circuit board of the information handling system, integrated onto another component such as chipset 510, in another suitable location, or a combination thereof. Network interface 580 includes a network channel 582 that provides an interface to devices that are external to information handling system 500. In a particular embodiment, network channel 582 is of a different type than peripheral interface 572 and network interface 580 translates information from a format suitable to the peripheral channel to a format suitable to external devices.

In a particular embodiment, network interface 580 includes a NIC or host bus adapter (HBA), and an example of network channel 582 includes an InfiniBand channel, a Fibre Channel, a Gigabit Ethernet channel, a proprietary channel architecture, or a combination thereof. In another embodiment, network interface 580 includes a wireless communication interface, and network channel 582 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 582 can be connected to an external network resource (not illustrated). The network resource can include another information handling system, a data storage system, another network, a grid management system, another suitable resource, or a combination thereof.

BMC 590 is connected to multiple elements of information handling system 500 via one or more management interface 592 to provide out-of-band monitoring, maintenance, and control of the elements of the information handling system. As such, BMC 590 represents a processing device different from processor 502 and processor 504, which provides various management functions for information handling system 500. For example, BMC 590 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 590 can vary considerably based on the type of information handling system. BMC 590 can operate in accordance with an Intelligent Platform Management Interface (IPMI). Examples of BMC 590 include an Integrated Dell® Remote Access Controller (iDRAC).

Management interface 592 represents one or more out-of-band communication interfaces between BMC 590 and the elements of information handling system 500 and can include an Inter-Integrated Circuit (I²C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 500, that is apart from the execution of code by processors 502 and 504 and procedures that are implemented on the information handling system in response to the executed code.

BMC 590 operates to monitor and maintain system firmware, such as code stored in BIOS/EFI module 542, option ROMs for graphics adapter 530, disk controller 550, add-on resource 574, network interface 580, or other elements of information handling system 500, as needed or desired. In particular, BMC 590 includes a network interface 594 that can be connected to a remote management system to receive firmware updates, as needed or desired. Here, BMC 590 receives the firmware updates, stores the updates to a data storage device associated with the BMC, and transfers the firmware updates to NVRAM of the device or system that is the subject of the firmware update, thereby replacing the currently operating firmware associated with the device or system, and reboots information handling system, whereupon the device or system utilizes the updated firmware image.

BMC 590 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 590, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by an “F2” boot option, or another protocol or API, as needed or desired.

In a particular embodiment, BMC 590 is included on a main circuit board (such as a baseboard, a motherboard, or any combination thereof) of information handling system 500 or is integrated into another element of the information handling system such as chipset 510, or another suitable element, as needed or desired. As such, BMC 590 can be part of an integrated circuit or a chipset within information handling system 500. An example of BMC 590 includes an iDRAC, or the like. BMC 590 may operate on a separate power plane from other resources in information handling system 500. Thus BMC 590 can communicate with the management system via network interface 594 while the resources of information handling system 500 are powered off. Here, information can be sent from the management system to BMC 590 and the information can be stored in a RAM or NVRAM associated with the BMC. Information stored in the RAM may be lost after power-down of the power plane for BMC 590, while information stored in the NVRAM may be saved through a power-down/power-up cycle of the power plane for the BMC.

Information handling system 500 can include additional components and additional busses, not shown for clarity. For example, information handling system 500 can include multiple processor cores, audio devices, and the like. While a particular arrangement of bus technologies and interconnections is illustrated for the purpose of an example, one of skill will appreciate that the techniques disclosed herein are applicable to other system architectures. Information handling system 500 can include multiple CPUs and redundant bus controllers. One or more components can be integrated together. Information handling system 500 can include additional buses and bus protocols, for example, I²C and the like. Additional components of information handling system 500 can include one or more storage devices that can store machine-executable code, one or more communications ports for communicating with external devices, and various input and output (I/O) devices, such as a keyboard, a mouse, and a video display.

For purposes of this disclosure information handling system 500 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 500 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 500 can include processing resources for executing machine-executable code, such as processor 502, a programmable logic array (PLA), an embedded device such as a System-on-a-Chip (SoC), or other control logic hardware. Information handling system 500 can also include one or more computer-readable media for storing machine-executable code, such as software or data.

As used herein, a hyphenated form of a reference numeral refers to a specific instance of an element and the un-hyphenated form of the reference numeral refers to the collective or generic element. Thus, for example, AI capable computing node “130-1” refers to an instance of an AI capable computing node, which may be referred to collectively as AI capable computing nodes “130” and any one of which may be referred to generically as an AI capable computing node “130.”

Although FIG. 3, and FIG. 4 show example blocks of method 300 and method 400 in some implementations, method 300 and method 400 may include additional blocks, fewer blocks, different blocks, or differently arranged blocks than those depicted in FIG. 3 and FIG. 4. Those skilled in the art will understand that the principles presented herein may be implemented in any suitably arranged processing system. Additionally, or alternatively, two or more of the blocks of method 300 and method 400 may be performed in parallel. For example, blocks 325, 330, 335, and 340 of method 300 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded in a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that causes a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
receiving, by a processor of an information handling system, a request for an artificial intelligence interaction;
determining requirements of an artificial intelligence model associated with the request for the artificial intelligence interaction;
discovering artificial intelligence-capable information handling systems in a local network;
generating a list of the artificial intelligence-capable information handling systems in the local network including the information handling system that received the request is included in the list; and
selecting a primary information handling system to execute the request based on a capability to execute the artificial intelligence interaction according to the requirements of the artificial intelligence model, wherein the primary information handling system is selected from the list of the artificial intelligence-capable information handling systems.

2. The method of claim 1, further comprising evaluating capability of the information handling system based on processing units of the information handling system.

3. The method of claim 1, further comprising determining a current capacity of the information handling system.

4. The method of claim 1, wherein the determining of the requirements of the artificial intelligence model is based on benchmarking results of the artificial intelligence model.

5. The method of claim 1, further comprising determining a score for each of the artificial intelligence-capable information handling systems and the information handling system that received the request.

6. The method of claim 5, further comprising ranking the artificial intelligence-capable information handling systems and the information handling system that received the request based on the score.

7. The method of claim 1, further comprising selecting a fallback information handling system to execute the request.

8. The method of claim 1, further comprising executing the artificial intelligence interaction on the primary information handling system.

9. An information handling system, comprising:
a processor; and
a memory coupled to the processor, the memory having program instructions stored thereon that upon execution cause the processor to:
receive a request for an artificial intelligence interaction;
determine requirements of an artificial intelligence model associated with the request for the artificial intelligence interaction;
discover artificial intelligence-capable information handling systems in a local network;
generate a list of the artificial intelligence-capable information handling systems in the local network including the information handling system that received the request is included in the list; and
select a primary information handling system to execute the request based on a capability to execute the artificial intelligence interaction according to the requirements of the artificial intelligence model, wherein the primary information handling system is selected from the list of the artificial intelligence-capable information handling systems.

10. The information handling system of claim 9, wherein the program instructions further cause the processor to evaluate capability of the information handling system based on processing units of the information handling system.

11. The information handling system of claim 9, wherein the program instructions further cause the processor to determine a current capacity of the information handling system.

12. The information handling system of claim 9, wherein the requirements of the artificial intelligence model are based on benchmarking results.

13. The information handling system of claim 9, wherein the program instructions further cause the processor to determine a score for each of the artificial intelligence-capable information handling systems and the information handling system that received the request.

14. A non-transitory computer-readable medium to store instructions that are executable to perform operations comprising:
receiving a request for an artificial intelligence interaction;
determining requirements of an artificial intelligence model associated with the request for the artificial intelligence interaction;
discovering artificial intelligence-capable information handling systems in a local network;
generating a list of the artificial intelligence-capable information handling systems in the local network including the information handling system that received the request is included in the list; and
selecting a primary information handling system to execute the request based on a capability to execute the artificial intelligence interaction according to the requirements of the artificial intelligence model, wherein the primary information handling system is selected from the list of the artificial intelligence-capable information handling systems.

15. The non-transitory computer-readable medium of claim 14, wherein the operations further comprise determining a current capacity of the information handling system.

16. The non-transitory computer-readable medium of claim 14, wherein the operations further comprise evaluating capabilities of the discovered artificial intelligence-capable information handling systems.

17. The non-transitory computer-readable medium of claim 14, wherein the operations further comprise executing the artificial intelligence interaction on the primary information handling system.

18. The non-transitory computer-readable medium of claim 14, wherein the operations further comprise determining a score for each of the artificial intelligence-capable information handling systems and the information handling system that received the request.

19. The non-transitory computer-readable medium of claim 18, wherein the operations further comprise ranking the artificial intelligence-capable information handling systems and the information handling system that received the request based on the score.

20. The non-transitory computer-readable medium of claim 14, wherein the determining of the requirements of the artificial intelligence model is based on benchmarking results.
